(19) United States
(12) Patent Application Publication
(10) Pub. No.: US 2018/0242717 A1
(43) Pub. Date: Aug. 30, 2018

(54) U-LOCK HOLDER

(71) Applicant: Lucas Risman Pelz, Chestnut Hill, MA (US)

(72) Inventor: Lucas Risman Pelz, Chestnut Hill, MA (US)

(21) Appl. No.: 15/442,403

(22) Filed: Feb. 24, 2017

(51) Int. Cl. A45F 3/04; E05B 71/00

(52) U.S. Cl. CPC A45F 3/04; A45F 2003/003; E05B 71/00

(57) ABSTRACT

A u-lock holder comprises at least one panel attachable to the backpack carried by an individual. The at least one panel at least partially defines an opening configured to receive and retain a u-lock about the backpack. The at least one panel can be positioned to intersect the sagittal plane of the individual. An upper edge of the at least one panel is configured to vertically support the u-lock and is positioned at an angle relative to the transverse plane of the individual. The upper edge of the u-lock holder is positioned proximate the scapular region of the individual in order to grasp the u-lock by reaching over either shoulder. The opening has a substantially consistent cross-sectional area such that the u-lock can be in a locked configuration when inserting and removing the u-lock. A method of retaining the u-lock with the u-lock holder is provided.

### FIELD OF THE INVENTION

The present invention relates generally to a lock holder, and more particularly, to a u-lock holder carried by an individual for retaining and carrying a u-lock.

### BACKGROUND OF THE INVENTION

A u-lock is a locking device that is widely used to lock various items, such when locking bicycles, motorcycles, scooter wheels, etc. to a structure or bike rack, for instance. These u-locks are typically removably coupled/locked to a vehicle frame during transit, or perhaps carried via a backpack, strap, etc., during transit. However, such means of carrying a u-lock can be cumbersome because of the location of the u-lock. For instance, the u-lock may be carried inside a backpack, or locked to a vehicle frame, or locked to strap or backpack. The problem is that such methods of carrying a u-lock require an individual to unlock the u-lock to remove and prepare it for use, or to remove the u-lock from inside a backpack. If the lock is simply secured to a strap, it may flop around when the user is cycling and bump into the user or the bicycle, for example. In any of these scenarios, an individual would be required to use both hands to retrieve the u-lock from its stored location. This can be a challenge when one hand is required for another purpose, such as navigation, holding a bicycle, or other needed purposes. Also, it can be cumbersome for an individual to bend over to grasp a u-lock carried on a frame, and then unlock it, and then re-lock it to secure the frame to a structure for secure storage of a bicycle, for instance. Likewise, it can be cumbersome and time-consuming for the individual to retrieve a u-lock when carried inside a backpack, for instance, or to unlock the u-lock when interlocked to a strap or other retaining means that requires unlocking the u-lock to retrieve it.

### SUMMARY OF THE INVENTION

Embodiments of the present invention provide a backpack having a u-lock holder for supporting and retaining a u-lock about or on the backpack. More particularly, the u-lock holder can comprise at least one panel attachable to the backpack carried by an individual. The at least one panel can at least partially define an opening configured to receive and retain the u-lock about the backpack. An upper edge of the at least one panel can be configured to vertically support the u-lock. The upper edge can be positioned at an angle relative to the transverse plane of the individual carrying the backpack.

In one example, the u-lock holder can comprise a lower edge opposite the upper edge. The opening can be configured to slidably receive a u-channel member of the u-lock from the upper edge to the lower edge of the opening. In one example, the at least one panel comprises a first side panel, a second side panel, and a central panel extending between and coupled to each of the first and second side panels. In one example, the opening has a substantially consistent cross-sectional area between the upper edge and the lower edge such that the u-lock can be in a locked configuration when inserting and removing the u-lock about the opening. In one example, the first side panel comprises a first support edge and the second side panel comprises a second support edge. The first and second side panels can each extend transverse to the central panel such that the first and second support edges vertically support ends of a lock member of the u-lock.

In some examples, the at least one panel is comprised of at least one of a woven fabric, polymer, rubber, plastic, metal, composite, and combinations thereof.

In one example, there is provided a backpack having a u-lock holder to support (e.g., vertically) and retain a u-lock about the backpack. The backpack can comprise at least one strap for carrying the backpack by an individual, and a support panel coupled to the at least one strap. The backpack can comprise a u-lock holder having at least one panel attached to the support panel. The at least one panel can at least partially define an opening configured to receive the u-lock. The at least one panel can have an upper edge configured to vertically support the u-lock. The upper edge can be positioned at an angle relative to the transverse plane of the individual carrying the backpack.

In one example, the at least one panel comprises a first side panel, a second side panel, and a central panel. The central panel can extend between and be coupled to each of the first and second side panels. The central panel is can be positioned substantially parallel to the coronal plane of the individual when the backpack is carried by the individual.

In one example, the u-lock holder can comprise a lower edge opposite the upper edge, and the opening can be configured to slidably receive a u-channel member of the u-lock from the upper edge to the lower edge of the opening.

In one example, the opening has a substantially consistent cross-sectional area between the upper edge and the lower edge such that the u-lock can be in a locked configuration when inserting and removing the u-lock about the opening.

In one example, the support panel is positionable adjacent a back of the individual such that the at least one panel of the u-lock holder is positioned to intersect the sagittal plane of the individual.

In one example, the upper edge of the u-lock holder is positioned on the support panel proximate the scapular region of the individual such that the individual can grasp the u-lock by reaching over either shoulder.

In one example, the support panel comprises a central vertical axis substantially parallel to the sagittal plane of the individual, and the u-lock holder comprises a holder central axis positioned at an angle offset relative to the central vertical axis of the support panel. In some examples, the angle of the holder central axis is between 5 and 75 degrees relative to the central vertical axis of the support panel. Preferably, the angle from a vertical axis is about 17 degrees to the right or to the left (depending on whether the holder is set up for right or left hand access.

In one embodiment, there is provided a method for retaining a u-lock to a backpack with a u-lock holder. The method can comprise inserting a u-lock into an opening of a u-lock holder of a backpack. The u-lock holder can have at least one panel with an upper edge configured to vertically support the u-lock. The method can comprise removing the u-lock from the u-lock holder. The upper edge of the u-lock holder can be positioned at an angle relative to the transverse plane of an individual carrying the backpack, such as the angles disclosed herein.

In one example, the method comprises maintaining the u-lock in a locked configuration when inserting or removing the u-lock from the u-lock holder.

In one example, the method comprises grasping the u-lock with a hand by reaching over a shoulder when inserting or removing the u-lock from the u-lock holder.

In one example, the method comprises wearing the backpack such that the u-lock holder is positioned proximate the scapular region.

In one example, the method of inserting the u-lock further comprises vertically supporting ends of a lock member of the u-lock with the upper edge to retain the u-lock about the backpack.

### BRIEF DESCRIPTION OF THE DRAWINGS

Preferred and alternative examples of the present invention are described in detail below with reference to the following drawings:

FIG. 1A is a perspective view of an individual carrying a backpack having a u-lock holder retaining a u-lock in accordance with an example of the present disclosure;

FIG. 1B is a perspective view of the backpack of FIG. 1A where the u-lock is being removed from the u-lock holder by the individual in accordance with an example of the present disclosure;

FIG. 2A is a rear left view of the backpack of FIG. 1A in accordance with an example of the present disclosure;

FIG. 2B is a rear right view of the backpack of FIG. 2A in accordance with an example of the present disclosure;

FIG. 2C is a top view of the backpack of FIG. 2A in accordance with an example of the present disclosure;

FIG. 2D is a right-tilted top view of the backpack of FIG. 2C in accordance with an example of the present disclosure; and

FIG. 3 is a perspective view showing anatomical planes of an individual.

### DETAILED DESCRIPTION OF THE PREFERRED EMBODIMENT

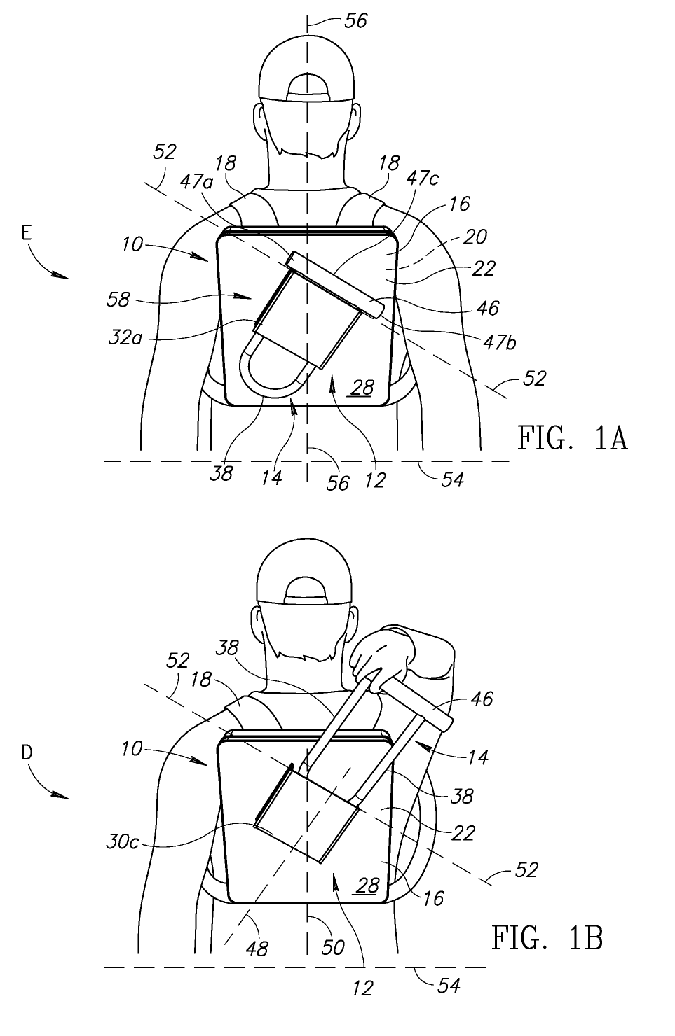

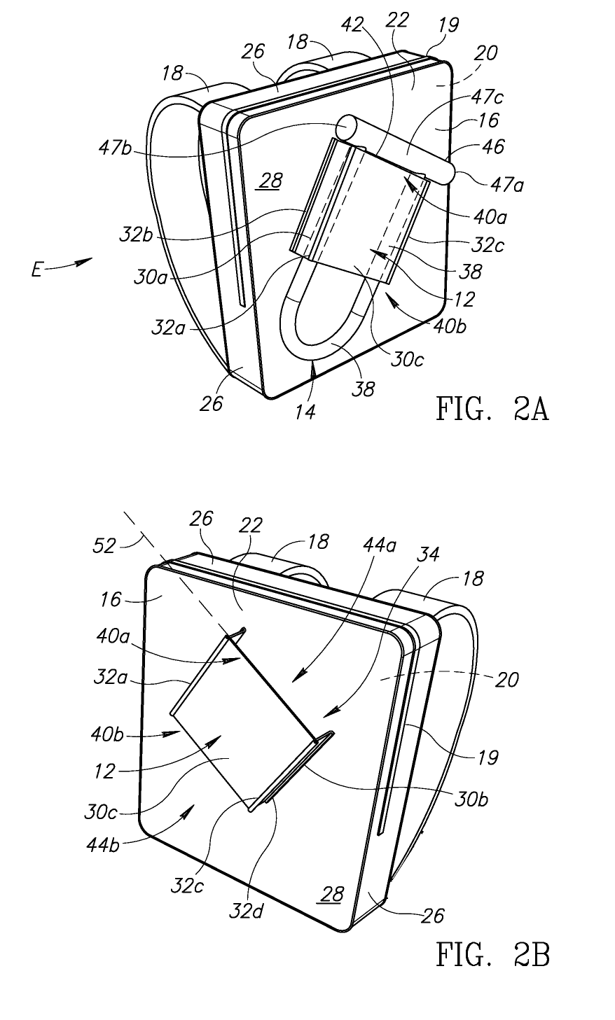

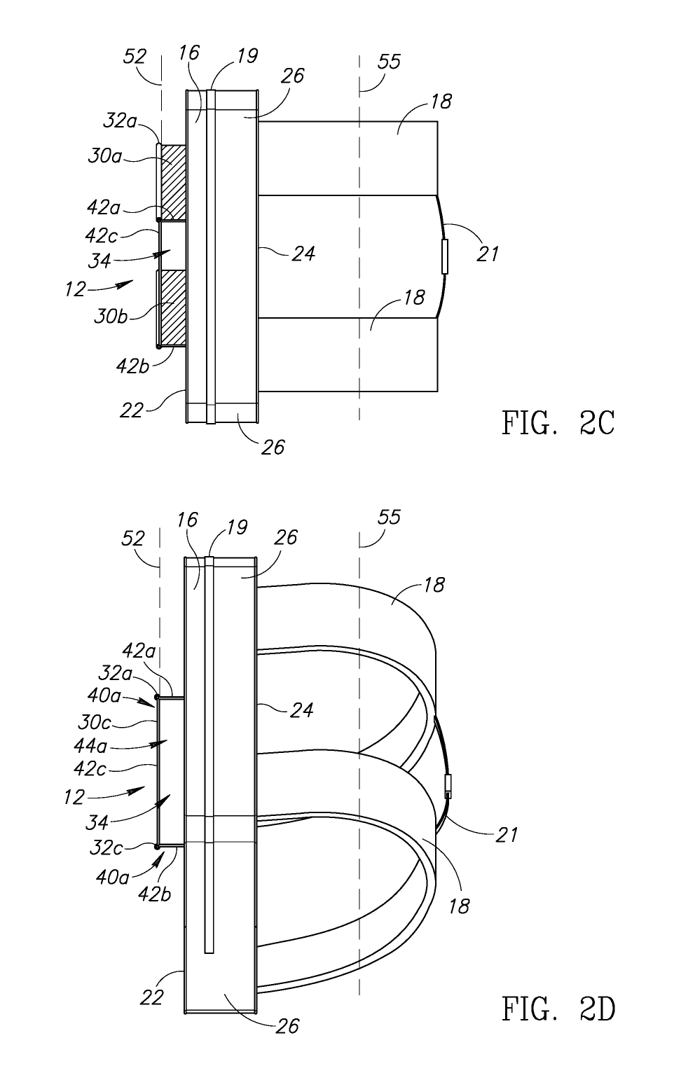

FIG. 1A illustrates a backpack 10 having a u-lock holder 12 supporting and retaining a u-lock 14 in an engaged configuration E, and FIG. 1B illustrates the u-lock 14 in a disengaged configuration D from the u-lock holder 12, as being removed by an individual. FIGS. 2A-2D show various views of the backpack 10 and the u-lock holder 12, as listed above. Notably, FIG. 2A shows the u-lock 14 supported by the u-holder 12 in the engaged configuration E.

The backpack 10 can comprise a bag 16 and a pair of shoulder straps 18 attached to the bag 16 in a traditional manner (i.e., straps 18 can be sewn/attached at the respective top and bottom portions of the bag 16). Triangular attachment portions (not shown here) can be sewn to respective sides of the bottom of the bag 16, and then the lower ends of the straps 18 can be sewn to respective triangular attachment portions. This can help better position the bag and straps on the wearer. Alternatively, a single shoulder strap could be used, like a courier or messenger bag. The bag 16 can comprise an internal cavity 20 (FIGS. 2A and 2B) for carrying belongings, for instance, which can be accessed by a zipper 19 about the top and sides of the bag 16. Preferably, the pack rides high on the back of the wearer, such that the lock is accessible and the pack rides high & tight. Doesn't move around when riding and gives access to reach the lock.

In one example, a chest strap 21 can be attached to each shoulder strap (FIGS. 2C and 2D) and can have a buckle that the wearer operates to buckle or un-buckle the chest strap 21 along the wearer's sternum, in a traditional manner.

The bag 16 can comprise a support panel 22 (e.g., see FIG. 1A) and a back panel 24 (see FIGS. 2C and 2D), which can each be substantially planar and substantially parallel to each other, for example. The back panel 24 is the portion of the bag 16 that can be directly attached to the straps 18 and that rests against the back (or front) of the individual while being worn or carried. The support panel 22 can be coupled (directly or indirectly) to the straps 18. The bag 16 can comprise sides 26 (e.g., top, bottom, left, and right sides) that can be comprised of a uniform strip of fabric attached/sewn to perimeter edges of the support panel 22 and perimeter edges of the back panel 24, for instance (see sides 26 of FIGS. 2A-2D). The backpack 10 can be any suitable bag or article designed to be carried by an individual. A backpack carrying a u-lock need not have an internal cavity; it can merely have a panel (e.g., like the support or back panel) coupled to the straps such that a primary purpose of the backpack is to carry a u-lock about a u-lock holder attached to a single panel.

In one example, the u-lock holder 12 is secured to an outer surface 28 of the support panel 22. In this manner, the u-lock holder 12 can comprise a first panel 30a, a second panel 30b, and a central panel 30c (FIGS. 2A-2D). A right linear edge of the first side panel 30a can be attached to a left side edge of the central panel 30 c to form seam 32 a. An opposing left linear edge of the first side panel 30a can be attached to the support panel 22 to form seam 32b (FIG. 2A). Likewise, a left linear edge of the second side panel 30b can be attached to an opposing right side edge of the central panel 30 c to form seam 32 c (FIG. 2B). Thus, an opposing right linear edge of the second side panel 30b can be attached to the support panel 22 to form seam 32d, as illustrated in FIG. 2B. Thus, in one example, seams 32a-d are each substantially parallel to each other and are approximately the same length. Some or all of the seams 32a-d can be formed by sewing fabric edges of panels together, and/or by adhering edges/panels together, and/or by other suitable means. The panels 30a-c can be comprised of a woven/webbed material (nylon, polyester, etc.) that is pliable yet sufficiently rigid (when attached to support panel 22) to support the weight of the u-lock 14 (approximately 2-5 pounds) about the backpack 10.

In another example, a u-lock holder can be formed of a singular piece of material that is attached at left and right side edges of the holder to the support panel 22 (i.e., forming only seams 32b and 32d). In this configuration, the u-lock holder could be sized and shaped to securely retain a u-lock to a backpack and can be formed of an elastic or stretchable material to allow some compliance or stretching to retain the u-lock to the backpack. In another example, a u-lock holder can be removably attached to the support panel 22, such as by implementing hook-and-loop fastener interfaces between the u-lock holder and the support panel 22 (or by implementing snaps, ties, tongue and groove, etc.).

The panels 30a-c of the u-lock holder 12 can at least partially define an opening 34 that extends from top to bottom of the u-lock holder 12 (FIGS. 2B-2D). In one example, the opening 34 is defined by boundaries of the panels 32a-c and the portion of the support panel 22 that is enveloped by the panels 32a-c. The opening 34 can comprise a substantially rectangular cuboid configuration that defines the 3D perimeter of the opening 34. Thus, the opening 34 can be effectively a rectangular slot (e.g., as partially defined by the c-channel shape of the u-lock holder 12) that slidably receives a u-channel member 38 of the u-lock 14, as illustrated in FIGS. 1A and 1B. A recess (not shown in the Figures) is provided at the top edge to provide clearance to grasp the lock rod in at least one preferred embodiment.

The panels 32a-c can collectively define an upper edge 40a and an opposing lower edge 40b (FIG. 2B), which can be substantially parallel to each other (as planes defined by respective edges). The upper edge 40a can comprise a first support edge 42a, a second support edge 42b, and a central support edge 42c (FIG. 2D). The upper edge 40a can define an upper opening 44a and the lower edge 40b can define a lower opening 44b (FIG. 2B). Thus, when the u-lock 14 is inserted into the opening 34 by an individual, a lower (arced) portion of the u-channel member 38 is received through the upper aperture 44a and extends through (and beyond/below) the lower aperture 44b when in the engaged position E (FIG. 2A). In an alternative example, the u-lock holder can have only the upper opening 44a such that a lower/perimeter edge (i.e., the lower opening 44b) is directly attached along the support panel 22. In this way, a “pocket-shaped” u-lock holder can be formed that would receive a u-lock about only one/upper opening.

As best illustrated in FIGS. 1A and 2A, at least some (or all) of the upper edge 40a of the u-lock holder 12 can be interfaced to (and vertically support) a lock member 46 of the u-lock 14. The “lock member 46” is the elongated rod component of the u-lock 14 that receives a key for unlocking/locking the lock member 46 to the u-channel member 38. More particularly, the first support edge 42a of the u-lock holder 12 (FIG. 2D) can be interfaced to a first end 47a of the lock member 46 (FIG. 2A). Likewise, the second support edge 42b can be interfaced to an opposing second end 47b of the lock member 46. Thus, a distance between the first and second support edges 42a and 42b of the u-lock holder 12 can be shorter than the distance of the lock member 46, but can further be greater than (or equal to) a width of side parallel portions of the u-channel 38 of the u-lock 14. In this configuration, the u-lock holder 12 can vertically support the u-lock 14.

Preferably, the central support edge 42c (FIG. 2D) of the central panel 32 c can be interfaced to a middle portion 47c (FIG. 2A) of the lock member 46 for additional vertical support of the u-lock 14. In any event, the u-lock holder 12 is formed and attached to the backpack 10 in this manner to vertically support the weight of the u-lock 14 to prevent it from falling through (below) the opening 34.

In one example, the u-lock holder 12 is positioned at an angle relative to the support panel 22, as exemplified in FIGS. 1A-2D. More specifically, the u-lock holder 12 can comprise a holder central axis 48 (FIG. 1B) that extends substantially centrally and substantially vertically through the central panel 30c, for example. The holder central axis 48 can be substantially parallel to seams 32a-d and/or substantially perpendicular to the upper edge 409a. Similarly, the support panel 22 can comprise a central vertical axis 50 that extends substantially centrally and substantially vertically of the support panel 22, which could be substantially perpendicular to left and right side edges of the support panel 22 and/or substantially perpendicular to the horizontal plane the individual, for example. As best illustrated in FIGS. 1A and 1B, the holder central axis 48 is positioned at an angle relative to the central vertical axis 50. In some examples, said angle can be at least 5 degrees and up to 75 degrees. Preferably, said angle is between 10 and 25 degrees to provide the most ease of access over the shoulder of the wearer, so as to ensure the u-lock does not inadvertently slide out of the u-lock holder. The angle may be to the right or to the left, depending on whether the holder is set up for right-hand access or left-hand access. As further discussed herein, said angular configuration is advantageous because it positions the u-lock holder 12 at an angle such that the individual can grasp the u-lock 14 with one hand from over a shoulder, such as the right shoulder. In some examples, the u-lock holder 12 can instead be positioned at a left angle (not shown) relative to the support panel 22, meaning that the individual could reach over the left shoulder to grasp and remove/insert the u-lock 14, for instance. In any event, retrieving and carrying of the u-lock 14 is relatively easy compared to existing systems, in part because the u-lock holder 12 is positioned on an external surface of the backpack 10 so the individual does not need to open the zipper 19, for instance, or engage with other devices to detach a u-lock holder from the backpack, for example. Another reason that an individual can more quickly and readily remove a u-lock is because the u-lock holder 12 (and backpack 10) is devoid of attachment devices or mechanisms that directly attach and secure the u-lock to the backpack, for instance (hence the u-lock holder 12 that slidably receives the u-lock 14 with a single motion by an individual by inserting or removing the u-lock 14).

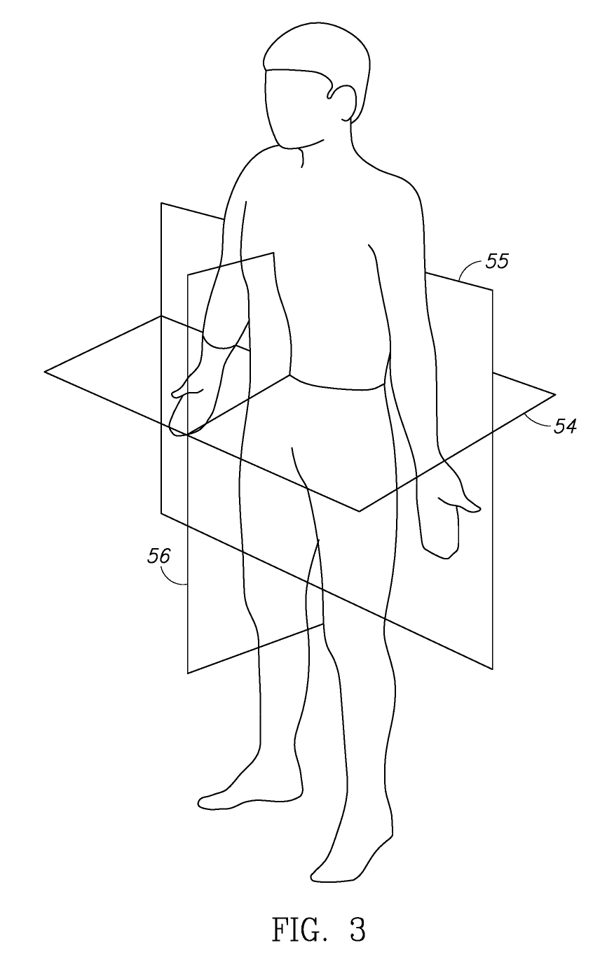

In another way to further describe this “angular configuration” of the u-lock holder 12, the upper edge 40a (some or all of support edges 42a-c) can define a lateral plane 52 that is positioned at an angle relative to the transverse plane 54 of the individual carrying the backpack 10 (FIGS. 1A, 1B, and 3). A “transverse plane” of the human body (also known the horizontal plane, axial plane, or transaxial plane) is an imaginary plane that divides the body into superior and inferior parts (see FIG. 3). It is perpendicular to the coronal/frontal plane and the sagittal plane (see more below). In the views of FIGS. 1A and 1B, the lateral plane 52 of the upper edge 40a is tilted downwardly to the right at an angle relative to the transverse plane 54. Said angle can be between 5 and 75 degrees, but preferably between 25 and 55 degrees. In one example, the central panel 30 c of the u-lock holder 12 can be positioned substantially parallel to the coronal plane 55 of the individual when the backpack 10 is carried (FIGS. 2D and 3). Of course, with a pliable backpack (e.g., comprised of cloth, polyester, etc.) there may be some level of deformation of the backpack 10 and the u-lock holder 12 due to the curvature of the individual's back/shoulders. However, the central panel 30 c (and the shape of the opening 34) can be substantially parallel to the coronal plane of the individual when worn by an individual.

In one example, the support panel 22 is positionable adjacent a back of the individual such that at least one panel (any of 32a-c) of the u-lock holder 12 is positioned to intersect the sagittal plane 56 of the individual, as illustrated in FIGS. 1A and 3. In this or another example, the upper edge 40a of the u-lock holder 12 can be positionable on the support panel 22 proximate the scapular region 58 (FIG. 1A; i.e., a “shoulder blade” area) of the individual such that the individual can grasp the u-lock 14 by reaching over (and/or around) the right shoulder with the right arm (or possibly with the left arm). Thus, the u-lock holder 12 is positioned on the backpack 10 at a height relative to the individual (e.g., proximate or adjacent the scapular region, and intersecting the sagittal plane 56) and at an angle (relative to the transverse plane 54) such that the u-lock holder 12 can vertically support the u-lock 14 (i.e., without any fastening or attachment means) in a manner that the individual can insert/remove the u-lock 14 about the backpack 10 with a single hand and without having to lock/unlock the u-lock 14. Many existing systems have various openings and/or fastening devices that receive and retain different portions of the u-channel (left and right sides) and/or the locking member of the u-lock, which requires two hands to insert or remove a u-lock because the individual must lock or unlock the u-lock about a pack/strap in order to carry the u-lock. Thus, the backpack 10 and the u-lock holder 12 of the present disclosure can support and retain the u-lock 14 (as described above) in a manner to remove the u-lock 14 with a simple, single step of grasping it with one hand over a shoulder to remove it from the u-lock holder 12, or a single step of sliding it into the u-lock holder 12 for carrying it. This can be advantageous when the other hand is being used to steer a bicycle, or hold the bicycle upright when preparing to use the u-lock to secure it to a bike rack, for instance.

The embodiments of the invention in which an exclusive property or privilege is claimed are defined as follows:

1. A u-lock holder of a backpack for retaining a u-lock about the backpack, the u-lock holder comprising:
at least one panel attachable to a backpack carried by an individual, the at least one panel at least partially defining an opening configured to receive a u-lock; and
an upper edge of the at least one panel configured to vertically support the u-lock, wherein the upper edge is positioned at an angle relative to the transverse plane of the individual carrying the backpack.

2. The u-lock holder of claim 1, further comprising a lower edge opposite the upper edge, wherein the opening is configured to slidably receive a u-channel member of the u-lock from the upper edge to the lower edge of the opening.

3. The u-lock holder of claim 2, wherein the at least one panel comprises a first side panel, a second side panel, and a central panel, the central panel extending between and coupled to each of the first and second side panels.

4. The u-lock holder of claim 3, wherein the opening has a substantially consistent cross-sectional area between the upper edge and the lower edge such that the u-lock can be in a locked configuration when inserting and removing the u-lock about the opening.

5. The u-lock holder of claim 3, wherein the first side panel comprises a first support edge and the second side panel comprises a second support edge, wherein the first and second side panels each extend transverse to the central panel such that the first and second support edges vertically support ends of a lock member of the u-lock.

6. The u-lock holder of claim 1, wherein the at least one panel is comprised of at least one of a woven fabric, polymer, rubber, plastic, metal, composite, and combinations thereof.

7. A backpack having a u-lock holder to vertically support and retain a u-lock about the backpack, the backpack comprising:
at least one strap for carrying the backpack by an individual;
a support panel coupled to the at least one strap; and
a u-lock holder having at least one panel attached to the support panel, the at least one panel at least partially defining an opening configured to receive a u-lock, the at least one panel having an upper edge configured to vertically support the u-lock, wherein the upper edge is positioned at an angle relative to the transverse plane of the individual carrying the backpack.

8. The backpack of claim 7, wherein the at least one panel comprises a first side panel, a second side panel, and a central panel, the central panel extending between and coupled to each of the first and second side panels.

9. The backpack of claim 8, wherein the central panel is positioned substantially parallel to the coronal plane of the individual when the backpack is carried by the individual.

10. The backpack of claim 7, wherein the u-lock holder further comprises a lower edge opposite the upper edge, wherein the opening is configured to slidably receive a u-channel member of the u-lock from the upper edge to the lower edge of the opening.

11. The backpack of claim 10, wherein the opening has a substantially consistent cross-sectional area between the upper edge and the lower edge such that the u-lock can be in a locked configuration when inserting and removing the u-lock about the opening.

12. The backpack of claim 7, wherein the support panel is positionable adjacent a back of the individual such that the at least one panel of the u-lock holder is positioned to intersect the sagittal plane of the individual.

13. The backpack of claim 12, wherein the upper edge of the u-lock holder is positioned proximate the scapular region of the individual such that the individual can grasp the u-lock by reaching over either shoulder.

14. The backpack of claim 7, wherein the support panel comprises a central vertical axis substantially parallel to the sagittal plane of the individual, and wherein the u-lock holder comprises a holder central axis positioned at an angle offset relative to the central vertical axis of the support panel.

15. The backpack of claim 14, wherein the angle of the holder central axis is between 5 and 75 degrees relative to the central vertical axis of the support panel.

16. A method for retaining a u-lock to a backpack with a u-lock holder, the method comprising:
inserting a u-lock into an opening of a u-lock holder of a backpack, the u-lock holder having at least one panel with an upper edge configured to vertically support the u-lock; and
removing the u-lock from the u-lock holder, wherein the upper edge of the u-lock holder is positioned at an angle relative to the transverse plane of an individual carrying the backpack.

17. The method of claim 16, further comprising maintaining the u-lock in a locked configuration when inserting or removing the u-lock from the u-lock holder.

18. The method of claim 16, further comprising grasping the u-lock with a hand by reaching over a shoulder when inserting or removing the u-lock from the u-lock holder.

19. The method of claim 18, further comprising wearing the backpack such that the u-lock holder is positioned proximate the scapular region.

20. The method of claim 16, wherein inserting the u-lock further comprises vertically supporting ends of a lock member of the u-lock with the upper edge to retain the u-lock about the backpack.
